(19) United States
(12) Patent Application Publication
(10) Pub. No.: US 2021/0300027 A1
(43) Pub. Date: Sep. 30, 2021

(54) PRINTING DEVICE, CONTROL METHOD FOR PRINTING DEVICE, AND STORAGE MEDIUM

(71) Applicant: CASIO COMPUTER CO., LTD., Tokyo (JP)

(72) Inventors: Tamotsu IRIE, Tokyo (JP); Atsushi SUKENORI, Tokyo (JP)

(21) Appl. No.: 17/204,580

(22) Filed: Mar. 17, 2021

(30) Foreign Application Priority Data
Mar. 25, 2020 (JP) 2020-054244

(51) Int. Cl. B41J 2/045

(52) U.S. Cl. CPC B41J 2/04536; B41J 2/04586

(57) ABSTRACT

Disclosed is a printing device including: at least one processor that arranges multiple nail outlines based on a predetermined reference line, the nail outlines being outlines of multiple nails, and obtains multiple image portions from an image, the image portions corresponding to the arranged nail outlines and including designs that are related to each other; and a print head that prints the corresponding image portions on the respective nails.

### CROSS-REFERENCE TO RELATED APPLICATION

The present application is based upon and claims the benefit of priority from the prior Japanese Patent Application No. 2020-054244, filed on Mar. 25, 2020, the disclosure of which, including description, claims, abstract and drawings, is incorporated herein by reference in its entirety.

### BACKGROUND

### Technical Field

The present disclosure relates to a printing device, a control method for the printing device, and a storage medium.

### Description of Related Art

Conventionally, there are known printing devices that print nail designs on person's fingernails and the like (for example, see JP 2012-55467 A). Such printing devices enable users to print nail designs without using nail salons or the like.

In such printing devices, scale adjustment or the like is generally performed by individually associating the design with each nail shape. Thus, when a design that has unity as a whole is to be printed on multiple nails, the design continuity is lost between adjacent nails.

### SUMMARY

According to an aspect of the present disclosure, there is provided a printing device including: at least one processor that arranges multiple nail outlines based on a predetermined reference line, the nail outlines being outlines of multiple nails, and obtains multiple image portions from an image, the image portions corresponding to the arranged nail outlines and including designs that are related to each other; and a print head that prints the corresponding image portions on the respective nails.

### BRIEF DESCRIPTION OF DRAWINGS

The accompanying drawings are not intended as a definition of the limits of the disclosure but illustrate embodiments of the disclosure, and together with the general description given above and the detailed description of the embodiments given below, serve to explain the principles of the disclosure, wherein:

FIG. 1 is a main part perspective view showing the internal configuration of a nail printing device in an embodiment;

FIG. 2 is a control block diagram showing a schematic control configuration of the nail printing device and a terminal device in the embodiment;

FIG. 3 is a flowchart showing the flow of printing processing in the embodiment;

FIG. 4 is a flowchart showing the flow of design editing processing in the embodiment;

FIGS. 5A to 5D are views for explaining a first operation example of the design editing processing in FIG. 4;

FIGS. 6A and 6B are views for explaining a second operation example of the design editing processing in FIG. 4;

FIGS. 7A and 7B are views for explaining the second operation example of the design editing processing in FIG. 4;

FIG. 8 is a view for explaining a third operation example of the design editing processing in FIG. 4;

FIGS. 9A to 9C are views for explaining the third operation example of the design editing processing in FIG. 4;

FIG. 10 is a flowchart showing the flow of design editing processing in a modification example of the embodiment;

FIG. 11 is a view for explaining an operation example of the design editing processing in FIG. 10;

FIGS. 12A and 12B are views for explaining the operation example of the design editing processing in FIG. 10;

FIGS. 13A and 13B are views for explaining the operation example of the design editing processing in FIG. 10; and

FIG. 14 is a view for explaining another modification example of the embodiment.

### DETAILED DESCRIPTION OF EMBODIMENTS

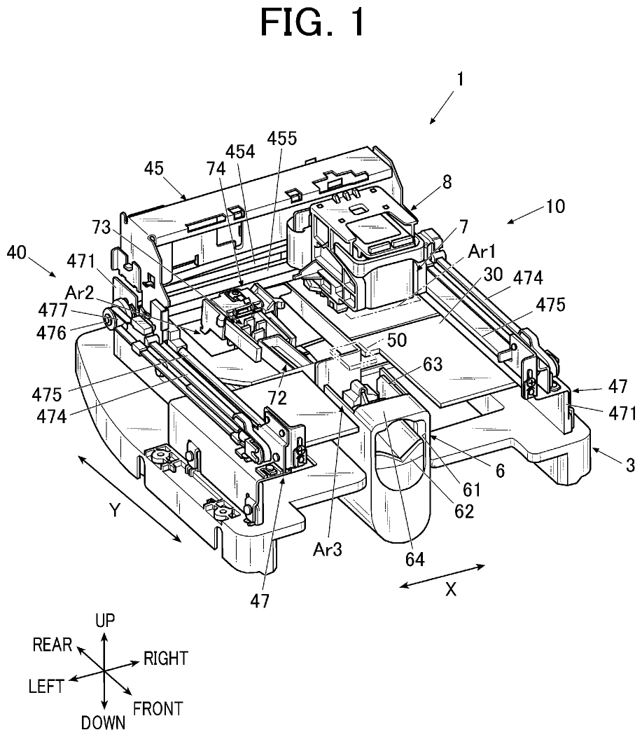

An embodiment of a printing device according to the present disclosure will be described with reference to FIGS. 1 to 14.

The embodiment described below is provided with various limitations technically preferable for carrying out the present disclosure. However, the scope of the present disclosure is not limited to the embodiment below or illustrated examples.

Furthermore, in the following embodiment, a case where the printing device is a nail printing device that performs printing on fingernail(s) and thumbnail(s) of hand(s) as a printing target will be described as an example. However, the printing target of the printing device in the present disclosure is not limited to the fingernail(s) or the thumbnail(s) of hand(s). For example, toenail(s) of foot (feet) may be the printing target. The printing target may also be targets other than nails, such as nail tips and surfaces of various accessories.

FIG. 1 is a main part perspective view showing the internal configuration of a nail printing device 1 according to the present embodiment.

In the following embodiment, the up, down, left, right, front and rear refer to the directions shown in FIG. 1. Furthermore, the X direction and the Y direction respectively refer to the left-right direction and the front-rear direction.

As shown in FIG. 1, the nail printing device 1 includes a base 3 in which various internal structures are incorporated.

On the upper side of the base 3, there is arranged a base upper plate 30 which is substantially flat. The base upper plate 30 is arranged at a height that is substantially flush with the surface of the nail (printing target surface) in a state in which the finger of the printing target (printing finger) is fixed to an after-mentioned finger fixing unit 6.

The finger fixing unit 6 is arranged in a portion on a front side of the base upper plate 30 and substantially in a center in the left-right direction. The finger fixing unit 6 is a box-like member having an opening 61 that opens to the front side of the nail printing device 1. The printing finger is inserted into the nail printing device 1 from the opening 61, and printing is performed to this nail.

A finger fixing member 62 that fixes the printing finger is arranged inside the finger fixing unit 6. The finger fixing member 62 pushes up and supports the printing finger from below, and is formed of, for example, a flexible resin.

The back portion (rear portion) of the top surface of the finger fixing unit 6 is open and forms a window 63. From the window 63, the nail of the finger inserted into the finger fixing unit 6 is exposed.

With the front portion of the top surface, the finger fixing unit 6 forms a finger presser 64 which prevents the printing finger from floating (rising) and regulates the position of the printing finger in the upward direction. The printing finger is supported by the finger fixing member 62 from the lower side, and the upper side of the printing finger is pressed by the finger presser 64, so that the position in the height direction of the surface of the nail of the printing finger (printing target surface) is determined at a predetermined position proper for printing by the printing unit 40.

A printing unit 40 that prints on the printing target surface is provided in the nail printing device 1. The printing target surface in the embodiment is the surface of the printing target. In the present embodiment, the printing target surface is the surface of a fingernail (including a thumbnail).

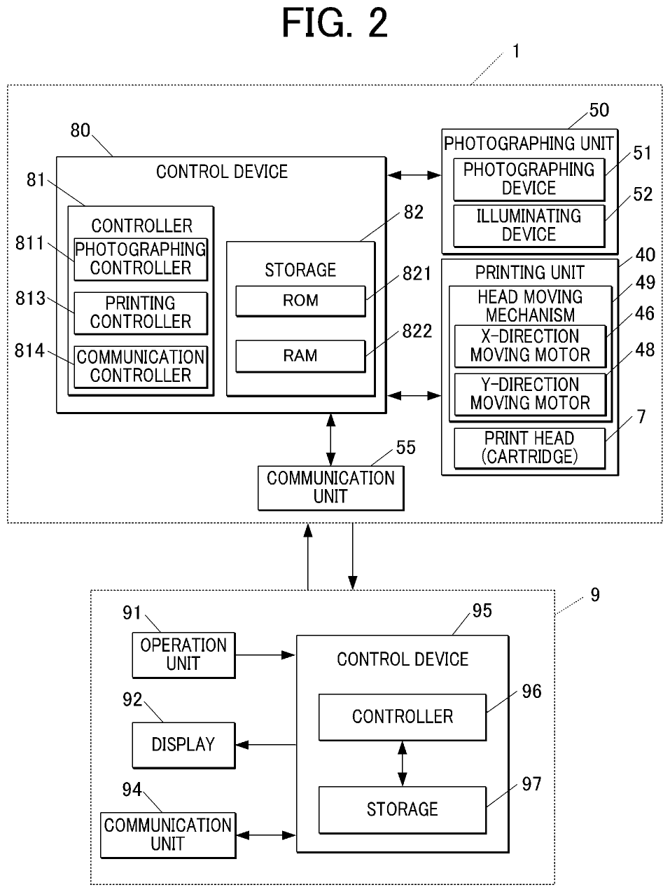

The printing unit 40 includes: the cartridge 7 that functions as a print head; the cartridge holder 8 that supports the cartridge 7; an X-direction moving stage 45 and an X-direction moving motor 46 (see FIG. 2) for moving the cartridge 7 in the X direction along the left-right direction; and Y-direction moving stages 47 and a Y-direction moving motor 48 (see FIG. 2) for moving the cartridge 7 in the Y direction along the front-rear direction.

The Y-direction moving stages 47 have support members 471 provided on both sides of the base upper plate 30 in the left-right direction and extending in the front-rear direction (Y direction).

To both ends in the extending direction of each of the support members 471 which form a pair, pulleys 477 are attached. Around the pulleys 477 on the left and right sides of the nail printing device 1, respective drive belts 474 extending in the front-rear direction are wound.

The pulleys 477 provided on the rear side of the nail printing device 1 are attached to both ends of a drive shaft portion 476. The Y-direction moving motor 48 (see FIG. 2) is connected to the drive shaft portion 476. By the Y-direction moving motor 48 being driven, the drive shaft portion 476 and the pulleys 477 attached thereto are properly rotated in forward and reverse directions as needed.

The rotation of pulleys 477 rotates the drive belts 474 wound around the pulleys 477, so that the X-direction moving stage 45 (and the cartridge 7 mounted on the X-direction moving stage 45) can move in the Y direction.

On the support members 471, guide shafts 475 extending in the front-rear direction are arranged parallel to the drive belts 474.

The X-direction moving stage 45 is formed in a rectangular box shape extending in the left-right direction (X direction), and is provided at the rear end portion of the base upper plate 30.

Into the right and left ends of the X-direction moving stage 45, the guide shafts 475 are respectively inserted. When the Y-direction moving motor 48 (see FIG. 2) is driven, the drive belts 474 rotate, so that the X-direction moving stage 45 can move in the Y direction along the guide shafts 475.

Pulleys (not shown in the drawings) are provided inside the X-direction moving stage 45, and a drive belt 454 extending in the left-right direction is wound around the pulleys. In the X-direction moving stage 45, a guide shaft 455 extending in the left-right direction is arranged substantially parallel to the drive belt 454.

The cartridge holder 8 that attachably and detachably holds the cartridge 7 is mounted on the X-direction moving stage 45.

On the back side of the cartridge holder 8 (rear side in FIG. 1), a holder support member (not shown in the drawings) through which the guide shaft 455 is inserted is provided.

The cartridge holder 8 is movable in the X direction along the guide shaft 455 in the X-direction moving stage 45 by the X-direction moving motor 46 (see FIG. 2) driving and the drive belt 454 rotating.

In the present embodiment, the X-direction moving motor 46, the Y-direction moving motor 48 and the like form a head moving mechanism 49 (see FIG. 2) that can move the cartridge 7 as a print head in the X direction and the Y direction. The operation of the head moving mechanism 49 is controlled by an after-mentioned control device 80.

The cartridge 7 in the present embodiment functions as a print head as mentioned above, and an inkjet type inkjet head that performs printing by spraying micro droplets of ink onto the surface to be printed of the printing target (nail) from the ink ejection section on the lower surface of the cartridge 7. The cartridge 7 can eject ink of yellow (Y), magenta (M), and cyan (C), for example.

The cartridge 7 is configured to move in the region on the upper side of the substrate upper plate 30.

On the right side of the rear portion of the base upper plate 30, a home position Ar1 that is a waiting area for the cartridge 7 (cartridge holder 8) during non-printing time is provided. A cap section (not shown in the drawings) that covers the ink ejection surface on the lower surface of the cartridge 7 to protect the surface from drying and the like is provided in the home position Ar1.

On the left side of the rear portion of the base upper plate 30, a maintenance area Ar2 for performing maintenance such as cleaning of the cartridge 7 during the non-printing time is provided. In the maintenance area Ar2, a purging section 72 that performs purge (spit) processing, a wiping section 73 that wipes the ink ejection surface, and a scraping section 74 that removes the ink attached to the wiping members of the wiping section 73 are provided.

The portion on a front side of the base upper plate 30 and substantially in a center in the left-right direction is the region corresponding to the window 63 of the finger fixing unit 6 and is a printing area Ar3 where the cartridge 7 performs the printing operation during the printing time.

FIG. 2 is a control block diagram showing the schematic control configuration of the nail printing device 1.

As shown in FIG. 2, the nail printing device 1 includes a photographing unit 50, a communication unit 55, and a control device 80 in addition to the printing unit 40 described above.

The photographing unit 50 includes a photographing device 51 and an illuminating device 52.

The photographing unit 50 is arranged above the window 63 of the finger fixing unit 6. The photographing unit 50 performs photographing of the printing finger arranged in the finger fixing unit 6 with the photographing device 51 while illuminating the nail of the printing finger with the illuminating device 52. Then, the photographing unit 50 obtains a nail image (an image of the finger including the nail image) that is an image of the nail of the printing finger.

The photographing unit 50 may be configured to be movable in the X and Y directions by the head moving mechanism 49 that moves the cartridge 7.

The photographing device 51 is, for example, a small-sized camera configured by including a CCD (Charge Coupled Device) type or CMOS (Complementary Metal Oxide Semiconductor) type solid imaging element which has approximately two million pixels or more and a lens. The illuminating device 52 is an illuminating lamp, such as a white LED, for example.

The communication unit 55 is configured to be able to transmit and receive information to and from an after-mentioned terminal device 9 that operates in cooperation with the nail printing device 1.

The communication between the nail printing device 1 and the terminal device 9 is performed by, for example, a wireless LAN. The communication between the nail printing device 1 and the terminal device 9 is not limited to this, and any method may be used. For example, a network line such as the Internet may be used, or wireless communication based on a near field communication standard such as Bluetooth (registered trademark) or Wi-Fi may be performed. Furthermore, this communication is not limited to wireless communication, and various types of data may be transmitted and received between the nail printing device 1 and the terminal device 9 by wired connection. The communication unit 55 includes an antenna chip or the like corresponding to the communication method of the terminal device 9.

The control device 80 is a computer that includes: a controller 81 configured by including a CPU (Central Processing Unit) not shown in the drawings; and a storage 82 configured by including a ROM (Read Only Memory) 821, a RAM (Random Access Memory) 822, and the like.

The storage 82 stores various programs and various types of data for operating the nail printing device 1.

Specifically, the ROM 821 of the storage 82 stores various programs such as a printing program for performing printing processing, for example. These programs are executed by the control device 80. Thereby, each part of the nail printing device 1 is controlled in an integrated manner.

The controller 81 includes functional sections such as a photographing controller 811, a printing controller 813, and a communication controller 814. The functions of these respective functional sections are realized by the cooperation of the CPU of the controller 81 and the program stored in the ROM 821 of the storage 82.

The photographing controller 811 controls the photographing device 51 and the illuminating device 52 of the photographing unit 50, and causes the photographing device 51 to photograph a nail image of a printing finger fixed to the finger fixing unit 6.

The image data of the nail image acquired by the photographing unit 50 is transmitted to the after-mentioned terminal device 9 via the communication unit 55. The image data may be stored in the storage 82.

The printing controller 813 outputs a control signal to the printing unit 40 on the basis of printing data transmitted from the terminal device 9, and controls the X-direction moving motor 46 and the Y-direction moving motor 48, cartridge 7, and the like of the printing unit 40 so as to perform printing on the nail according to the printing data.

The communication controller 814 controls the operation of the communication unit 55. In the present embodiment, the communication controller 814 controls communication with the terminal device 9, and controls to receive printing data or the like when the printing data is transmitted from the terminal device 9.

The nail printing device 1 in the present embodiment is configured to be able to communicate with the terminal device 9, and executes the printing operation and the like on the basis of the operation instruction from the terminal device 9.

The terminal device 9 is, for example, a mobile terminal such as a smartphone or a tablet. However, the terminal device 9 is not particularly limited as long as the terminal device 9 can communicate with the nail printing device 1. For example, the terminal device 9 may be a notebook or stationary personal computer, a terminal device for a game, or the like.

Specifically, the terminal device 9 includes an operation unit 91, a display 92, a communication unit 94, a control device 95, and the like.

The operation unit 91 can perform various inputs and settings according to user operations. When the operation unit 91 is operated, an input signal corresponding to the operation is transmitted to the control device 95. In the present embodiment, a touch panel is integrally provided on the surface of the display 92, and the user can perform various input/setting operations by touch operations on the touch panel.

The operation unit 91 for performing various input/setting operations is not limited to the touch panel. For example, various operation buttons, a keyboard, a pointing device, and the like may be provided as the operation unit 91.

In the present embodiment, the user can select a nail design to be printed on the nail by operating the operation unit 91.

The touch panel configured in the display 92 displays various display screens under the control of a controller 96 to be described later.

In the present embodiment, the display 92 can display a nail design (printing design image) which was input or selected by the user from the operation unit 91, an image which was transmitted from the nail printing device 1, and the like. Additionally, the display 92 displays a nail outline display/registration screen for displaying the nail image and recognizing and registering the nail outline, a nail outline selecting screen for displaying a list of registered sets of nail outlines and selecting nail outlines, a printing data editing screen for editing printing data of each nail outline from multiple nail outlines and image data, a printing data transmitting screen for transmitting CMY printing data obtained by fitting the printing data to the shape of nail outline to a printer, and the like.

The communication unit 94 can transmit printing data to the nail printing device 1. Furthermore, when data such as a nail image is transmitted from the nail printing device 1, the communication unit 94 receives the transmitted data. The communication unit 94 includes a wireless communication module that can communicate with the communication unit 55 of the nail printing device 1.

The communication unit 94 may be any communication unit as long as the communication unit can communicate with the nail printing device 1, and a communication unit that matches the communication standard of the communication unit 55 of the nail printing device 1 is applied as the communication unit 94.

The control device 95 is a computer that includes: a controller 96 configured by including a CPU (Central Processing Unit) not shown in the drawings; and a storage 97 configured by including a ROM (Read Only Memory) and a RAM (Random Access Memory) not shown in the drawings.

The storage 97 stores various types of data and programs for operating each part of the terminal device 9.

Specifically, the ROM or the like in the present embodiment stores various programs such as a nail print application program for performing nail printing using the nail printing device 1 in addition to an operation program for controlling each part of the terminal device 9 in an integrated manner. The control device 95 expands and executes these programs in a working area of the RAM, for example, so that the terminal device 9 is controlled.

The data of printing design images, information on nail images and nail shapes (nail outlines), and the like are stored (or have been stored in advance) in the storage 97 of the present embodiment.

The controller 96 controls the operation of each part of the terminal device 9 in an integrated manner. The controller 96 implements various functions for performing printing on the nail in cooperation with a program stored in the storage 97.

Next, the operation of nail printing device 1 when executing printing on the nail will be described.

The overall flow of printing processing of the nail printing device 1 will be described.

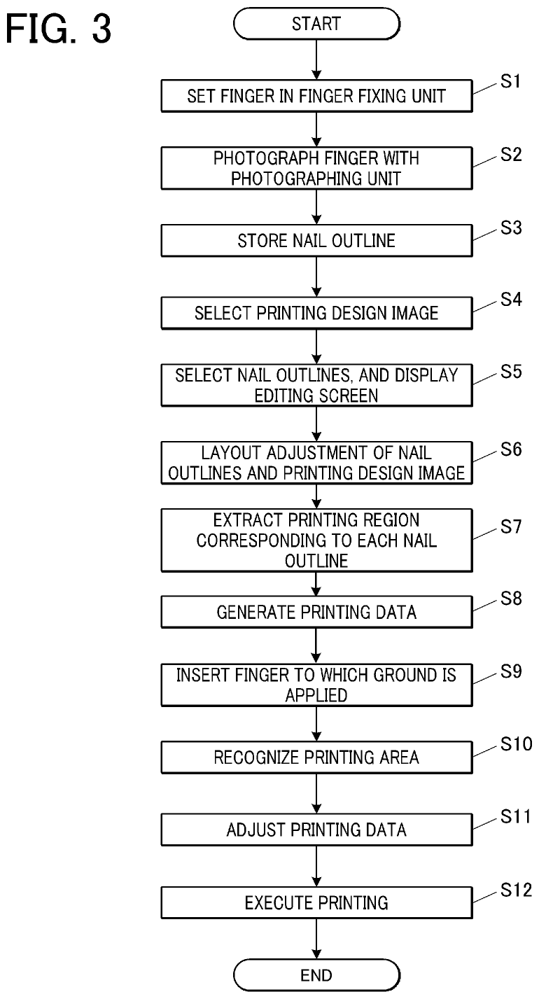

FIG. 3 is a flowchart showing the flow of printing processing in the present embodiment.

In the printing processing of the present embodiment, a design having unity as a whole is printed on multiple nails (whole designs on the multiple nails form a unified single design).

Hereinafter, the control device 95 (controller 96) of the terminal device 9 operated by the user is described as a main subject that executes the processing. However, the operation control of the nail printing device 1 is executed in cooperation with the control device 80 (controller 81) of the nail printing device 1 through the communication unit as needed.

As shown in FIG. 3, when the printing processing is executed and the user places a finger in the finger fixing unit 6 (step S1), the controller 96 obtains a nail image by photographing the fingernail with the photographing unit 50 (step S2), and recognizes the nail shape (nail outline) from this nail image and stores (registers) the recognized nail shape (nail outline) in the storage 97 (step S3).

By repeating the steps S1 to S3 multiple times, the photographing and shape recognition are successively performed for the multiple nails and multiple nail outlines are obtained in advance.

The controller 96 then selects a printing design image to be printed on the nails according to a user operation (step S4). In this step, the printing design image to be selected is the entire image which is divided into the multiple nails and printed.

The controller 96 selects multiple nail outlines and causes the nail outlines to be displayed in the editing screen (display 92) according to a user operation (step S5), and performs layout adjustment of the nail outlines and the printing design image (step S6).

The controller 96 then extracts a printing region corresponding to each of the nail outlines from the printing design image (step S7), and generates printing data for each of the nails (step S8).

When the user places a finger to which a ground was applied in the finger fixing unit 6 (step S9), the controller 96 obtains the nail image with the photographing unit 50, and recognizes a printing area to which the ground is applied from this nail image (step S10).

After the controller 96 performs adjustment by performing fitting or the like of the printing data corresponding to the photographed nail to the printing area (step S11), the controller 96 transmits this printing data to the nail printing device 1, to execute printing with the printing unit 40 (step S12).

The steps S9 to S12 are repeated multiple times for the number of fingers to be printed. That is, the multiple fingers (nails) to be printed are sequentially placed in the finger fixing unit 6, and each time the finger (nail) is placed, the printing data corresponding to the finger (nail) is adjusted to execute printing.

After the printing has completed for all the nails, the controller 96 ends the printing processing.

The design editing processing executed in the printing processing will be described.

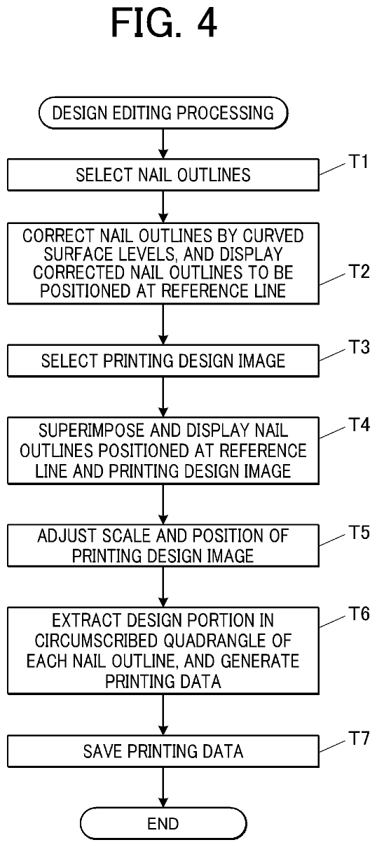

FIG. 4 is a flowchart showing the flow of design editing processing.

The design editing processing is processing of editing allocation of the printing design image to the nails, and generating (or correcting) multiple pieces of printing data corresponding to the nails. In the above-mentioned printing processing, this design editing processing may be performed in the layout adjustment of step S6 or may be performed as needed by a predetermined operation between steps S4 to S11, for example.

As shown in FIG. 4, when the design editing processing is executed, the controller 96 first selects multiple nail outlines from among the nail outlines stored (registered) in the storage 97 according to a user operation (step T1).

In the present embodiment, the nail outline data is registered having 10 nails at most for one person as one set. The registered information includes the XY coordinate values, the person's name, the registration date, and the curved surface level of nail of the nail outline. The curved surface level of nail is obtained by ranking the nail shape which is curved in the nail width direction by the relationship between the nail width and the nail height. The curved surface level is divided into six levels from 0 to 5 (0: curved degree is small (flat surface) to 5: curved degree is large).

The controller 96 causes the display 92 to display each of the nail outlines in the shape which was corrected according to the curved surface level of the nail outline (step T2).

In this step, each of the selected nail outlines is corrected in the horizontal direction on the basis of the setting of curved surface level. When the curved surface level is larger, the area of the inclined portion is increased, and thus the outline is enlarged in the horizontal direction.

In step T2, the nail outlines to which curved surface correction was performed are arranged to be positioned (aligned) at a predetermined reference line on the display 92.

The reference line defines arrangement of the nail outlines, or further defines the positional relationship with the printing design image. The reference line is a straight line along the left-right direction of the display 92 (the left-right direction of the printing design image in the display 92), for example. The line type of the reference line is not particularly limited, and may be arbitrarily set by the user or automatically set on the basis of the printing design image, for example. The information on the reference line may be added to the printing design image in a metadata manner.

The way to position (associate) the reference line and the nail outlines is not particularly limited, and the reference line may be positioned at the lower ends of the nail outlines, the upper ends of the nail outlines, or the center between the upper ends and the lower ends.

According to a user operation, the controller 96 selects the printing design image (image data) to be printed on the nail from among printing design images which are stored in the storage 97, for example (step T3), and thereafter causes the display 92 to superimpose and display the printing design image and the nail outlines such that the printing design image becomes the background of the nail outlines which are arranged to be aligned at the reference line (step T4). The step T3 may be omitted when the printing design image has been selected in advance in the above-mentioned step S4.

The controller 96 then adjusts the scale (size) and the position of the printing design image (step T5). In this step, while seeing the display 92, the user adjusts the allocation of design to each of the nail outlines such that feature points of the printing design image are printed on the nails appropriately, for example.

Specifically, for example, the scale and the position of the printing design image which is the background are adjusted by a gesture operation (swiping, pinching in, pinching out, rotating, or the like) on the display 92 (touch panel) performed by the user, and the design portion to be printed on each nail region (region inside the nail outline) is associated.

The interval between two adjacent nail regions may be adjusted together. This interval may be an interval when circumscribed quadrangles of the nail regions contact each other (gap “0”), an interval when a certain gap is provided (gap “+”), or an interval in a slightly overlapping state (gap “−”).

The controller 96 extracts the design portion corresponding to each of the nail outlines in a form of a circumscribed quadrangle of the nail outline from the printing design image, and generates the printing data corresponding to each of the nail outlines (step T6). When the adjacent nail regions are set to contact each other (gap is 0), for example, the design portions may be extracted in an integrated manner from the printing design image in a form of a circumscribed quadrangle of the whole nail outlines which are arranged.

The controller 96 stores each piece of the generated printing data in the storage 97 (step T7), and thereafter ends the design editing processing.

A first operation example of the above-mentioned design editing processing will be described.

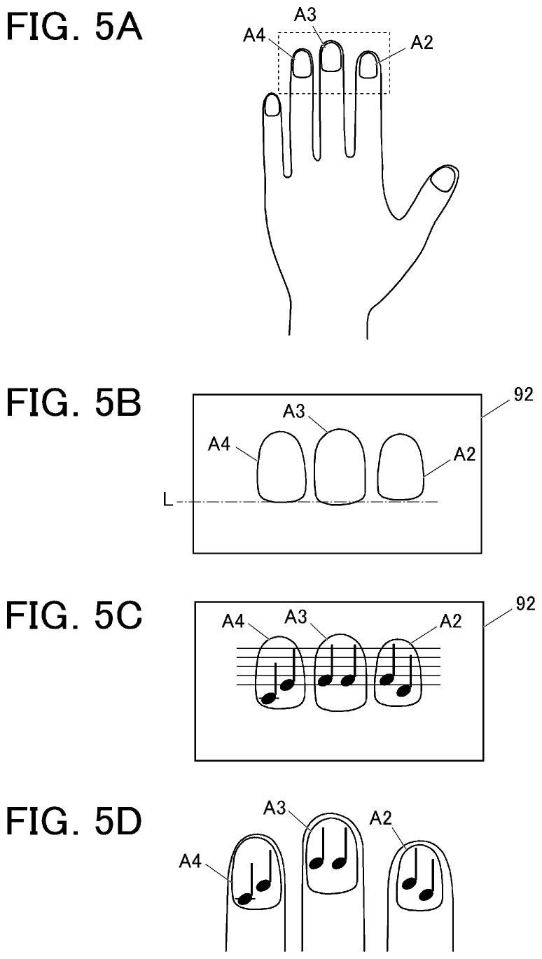

FIGS. 5A to 5D are views for explaining the first operation example. FIG. 5A is a view of selecting printing fingers, FIG. 5B is a view of displaying the multiple nail outlines positioned at a reference line, FIG. 5C is a view of superimposing and displaying the nail outlines on the printing design image, and FIG. 5D is a view showing the printing results.

As shown in FIG. 5A, in the first operation example, when the user selects the index finger, middle finger and ring finger of the left hand of a same person as printing fingers, the respective nail outlines A2 to A4 are selected (step T1).

After the selected nail outlines A2 to A4 are corrected on the basis of the settings of curved surface levels, as shown in FIG. 5B, the nail outlines A2 to A4 are displayed on the display 92 having the lower ends match the straight reference line L in the left-right direction and being arranged along the arrangement of fingers according to a user operation (step T2).

When the user next selects image data of a musical score (staff and notes) as the printing design image (step T3), as shown in FIG. 5C, the nail outlines A2 to A4 are superimposed on this printing design image and displayed on the display 92 (step T4).

The user adjusts the interval between the nail outlines A2 to A4 and the scale and position of the background image by a gesture operation or the like on the display 92 such that a desired design portion (for example, notes) is arranged on each of the nail outlines A2 to A4 (step T5).

The design portion of notes corresponding to each of the nail outlines A2 to A4 is then extracted from the printing design image in the form of a circumscribed quadrangle of the nail outline, and the printing data corresponding to each of the nail outlines A2 to A4 is generated (step T6).

When printing is executed on the basis of each piece of the generated printing data, as shown in FIG. 5D, the design portion associated with each nail of the index finger, the middle finger and the ring finger (nail outlines A2 to A4) is printed on the corresponding nail.

In such a way, the design having unity as a whole is printed on the multiple nails, and there are obtained designs having scales and positions corresponding to each other when these nails are arranged sideways.

A second operation example of the above-mentioned design editing processing will be described.

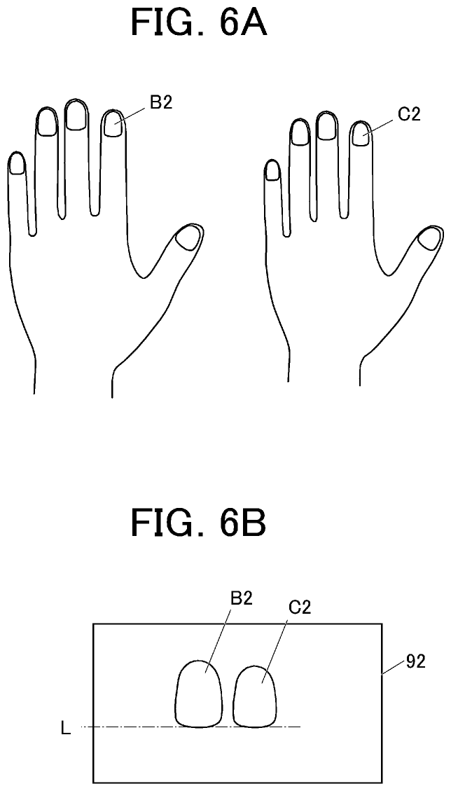

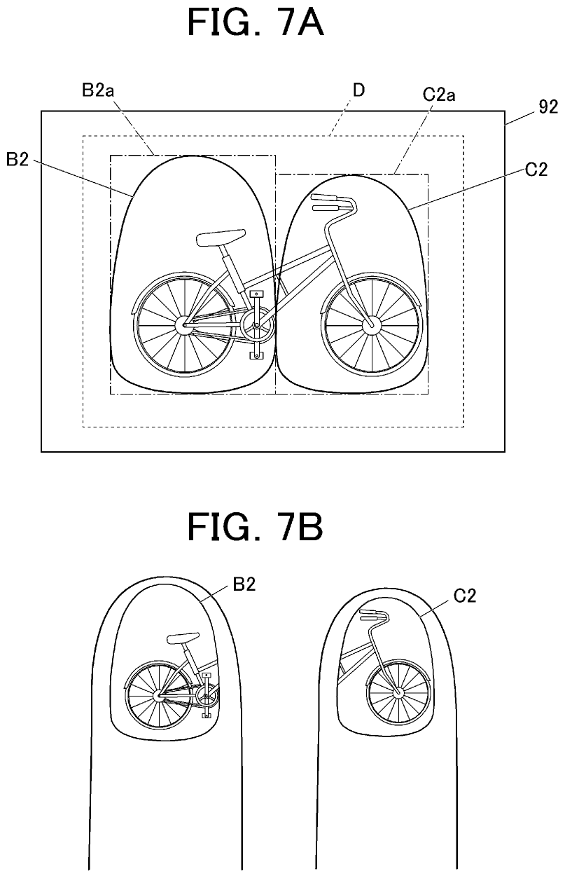

FIGS. 6A to 6B and 7A to 7B are views for explaining the second operation example. FIG. 6A is a view of selecting printing fingers, FIG. 6B is a view of displaying the multiple nail outlines positioned at a reference line, FIG. 7A is a view of superimposing and displaying the nail outlines on the printing design image, and FIG. 7B is a view showing the printing results.

As shown in FIG. 6A, in the second operation example, when the user selects the index finger of the left hand of B (person) and the index finger of the left hand of C (person) as printing fingers, the respective nail outlines B2 and C2 are selected (step T1).

After the selected nail outlines B2 and C2 are corrected on the basis of the settings of curved surface levels, as shown in FIG. 6B, the nail outlines B2 and C2 are displayed on the display 92 while having the lower ends match the straight reference line L in the left-right direction and being arranged along the arrangement of fingers according to a user operation (step T2).

When the user next selects image data of a bicycle as the printing design image D (step T3), as shown in FIG. 7A, the nail outlines B2 and C2 are superimposed on this printing design image D and displayed on the display 92 (step T4).

The user adjusts the interval between the nail outlines B2 and C2 and the scale and position of the background image by a gesture operation or the like on the display 92 such that desired design portions (for example, back and front wheels of the bicycle) are arranged for the respective nail outlines B2 and C2 (step T5).

The design portions corresponding to the respective nail outlines B2 and C2 are extracted from the printing design image D in the form of respective circumscribed quadrangles B2a and C2a of the nail outlines B2 and C2, and the printing data corresponding to each of the nail outlines B2 and C2 is generated (step T6).

When printing is executed on the basis of each piece of the generated printing data, as shown in FIG. 7B, the design portion associated with each nail of the index finger of the left hand of B and the index finger of the left hand of C (each of nail outlines B2 and C2) is printed on the corresponding nail.

In such a way, it is possible to print a design having unity as a whole even between the nails of different persons. Since such design printing completes the pattern by having two persons as in a tally, the design printing can be also used for sharing and limiting information, for example. To be specific, the former part of a phone number may be printed on a finger of B and the latter part may be printed on a finger of C. A fixed part of a map may be printed on a finger of B and the rest may be printed on a finger of C. The above design printing can also be used for identifying individuals in a group (family, company) consisting of multiple persons, and can also be used for game usages.

A third operation example of the above-mentioned design editing processing will be described.

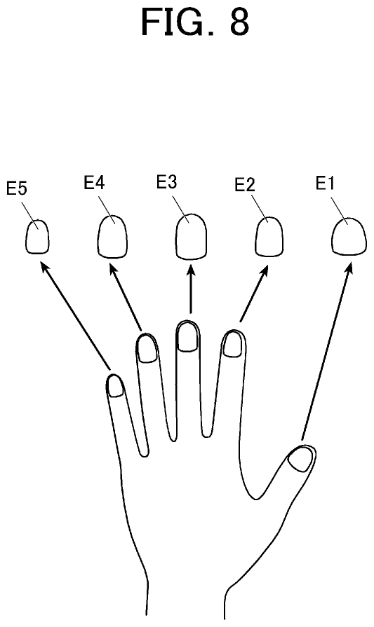

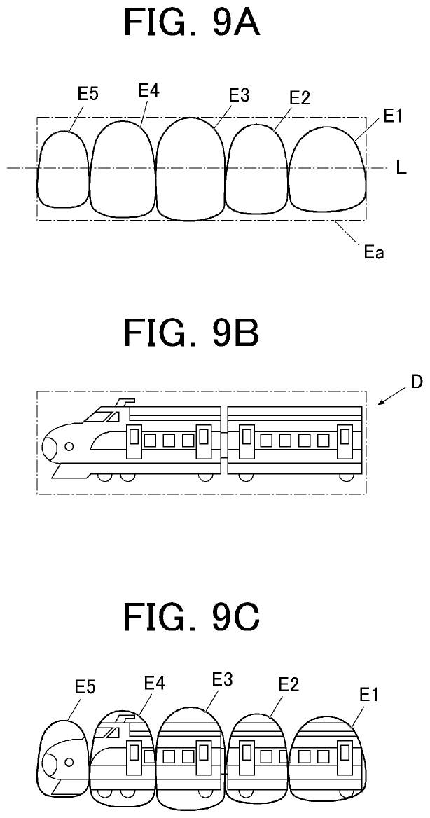

FIGS. 8 and 9A to 9C are views for explaining the third operation example. FIG. 8 is a view of selecting printing fingers, FIG. 9A is a view of arranging the multiple nail outlines aligned at a reference line, FIG. 9B is a view showing a printing design image, and FIG. 9C is a view showing the printing results.

As shown in FIG. 8, in the third operation example, when the user selects, as printing fingers, the thumb, index finger, middle finger, ring finger and little finger of the left hand of a same person that were photographed and recognized in advance, the respective nail outlines E1 to E5 are selected (step T1). When a nail(s) inclined to the left or right of the finger(s) is recognized, the inclination is corrected to align each central line which is along the longitudinal direction of the finger, and then recognition is performed.

After the selected nail outlines E1 to E5 are corrected on the basis of the settings of curved surface levels, as shown in FIG. 9A, the nail outlines E1 to E5 are displayed on the display 92 while having the centers between upper and lower ends match the straight reference line L in the left-right direction and being arranged to contact each other along the arrangement of fingers according to a user operation (step T2).

As shown in FIG. 9B, when the user next selects image data of the Shinkansen (Japan's bullet train) as the printing design image D (step T3), the nail outlines E1 to E5 are superimposed on this printing design image and displayed on the display 92 (steps T4, T5).

The design portion of the Shinkansen corresponding to all the nail outlines E1 to E5 is then extracted from the printing design image D as the portion corresponding to the circumscribed quadrangle Ea of the whole of all the nail outlines E1 to E5. On the basis of the position and the range of each of the nail outlines E1 to E5 in the circumscribed quadrangle Ea, the multiple design portions corresponding to the respective nail outlines E1 to E5 are extracted from the design portion corresponding to all the nail outlines E1 to E5, and the printing data corresponding to each of the nail outlines E1 to E5 is generated (step T6).

When printing is executed on the basis of each piece of the generated printing data, as shown in FIG. 9C, the design portion associated with each nail of the thumb, the index finger, the middle finger, the ring finger and the little finger (each of nail outlines E1 to E5) is printed on the corresponding nail.

Though a continuous design is printed on adjacent nails in FIG. 9C, gaps (finger portions) generated between the adjacent nails when multiple fingers are arranged may be considered and printing of the design portions corresponding to the gaps may be omitted. As for the gaps in this case, default values of general finger sizes may be used or the gaps may be detected from the nail images.

As described above, according to the present embodiment, multiple nail outlines are arranged on the basis of a predetermined reference line, multiple design portions corresponding to the multiple nail outlines are obtained from a printing design image, and printed on the respective corresponding nails.

Thus, it is possible to arrange multiple design portions corresponding to multiple nail outlines to be aligned at a reference line. Accordingly, it is possible to suitably allocate and print designs which are related to each other on the multiple nails. Therefore, it is possible to suitably print even a large design which has a joint(s) and cannot be expressed by only a single nail, as in painting on a folding screen, a shoji, a fusuma, and a folding fan, for example.

According to the present embodiment, the nail outlines are associated with the printing design image, and design portions corresponding to the nail outlines are extracted from the printing design image. Thus, multiple design portions maintaining their positional relationship in the printing design image are extracted. Accordingly, it is possible to further suitably print a design having unity as a whole on the multiple nails.

According to the present embodiment, after the nail outlines and the printing design image are superimposed and displayed on the display 92, the size and the position of the printing design image and the gap between two adjacent nail outlines are adjusted on the basis of a user operation.

Thus, the user can suitably adjust the allocation of the design to the nail outlines while seeing the display 92.

A modification example in the above embodiment will be described.

The present modification example is different from the above embodiment mainly in the contents of design editing processing. Hereinafter, these differences will be particularly described. The same reference numerals are provided to the same components as the above embodiment, and the explanation thereof is omitted.

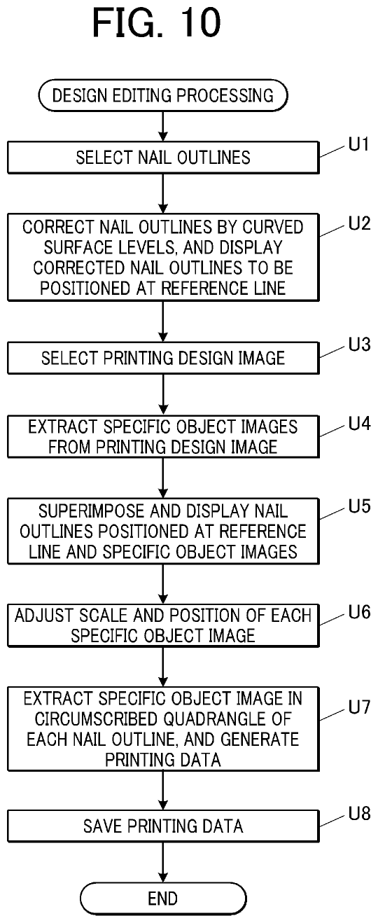

FIG. 10 is a flowchart showing the flow of design editing processing in the present modification example.

As shown in FIG. 10, when the design editing processing is executed, the controller 96 selects multiple nail outlines from among nail outlines stored (registered) in the storage 97 according to a user operation (step U1), and causes the display 92 to display the selected nail outlines in shapes which were corrected according to the respective curved surface levels, so as to be aligned at a reference line (step U2).

These steps U1 and U2 are performed similarly to the steps T1 and T2 of the above embodiment.

The controller 96 then selects a printing design image (image data) to be printed on the nails from among printing design images stored in the storage 97, for example, according to a user operation (step U3), and thereafter extracts multiple specific object images from this printing design image (step U4).

Each of the specific object images is detected and extracted from the printing design image as an image portion having a predetermined feature amount selected by the user, for example, by image processing. Any known method can be used for this object detection. The specific object image is not particularly limited as long as it can be extracted by image processing. The user may select the specific object image by specifying a range or the like, or the user may select a specific object image to be used for the printing from among multiple specific object images which were automatically extracted.

The controller 96 then causes the display 92 to superimpose and display the specific object images on the multiple nail outlines arranged to be aligned at the reference line (step U5). That is, the specific object images and the nail outlines are associated with each other on the basis of the reference line. This association may be set by the user or may be set automatically.

The way of fitting (associating) of the reference line and the specific object images is not particularly limited. For example, the reference line may be fit to the lower ends, upper ends or the centers of the upper and lower ends of the specific objects.

The controller 96 adjusts the scale (size) and the position of each of the multiple specific object images (step U6).

For example, similarly to the step T5 in the above embodiment, the scales and positions of the respective specific object images are adjusted by a gesture operation or the like on the display 92 (touch panel) by the user. Alternately, the sizes of all the specific object images may be changed at a same rate such that all the specific object images are arranged in the corresponding nail outlines.

In this step, the gap between adjacent nail regions may also be adjusted similarly to the step T5 in the above embodiment.

The controller 96 extracts the specific object images corresponding to the respective nail outlines from the printing design image in the form of circumscribed quadrangles of the respective nail outlines, and generates printing data corresponding to each of the nail outlines (step U7).

The controller 96 stores each piece of the generated printing data in the storage 97 (step U8), and thereafter ends the design editing processing.

An operation example of design editing processing in the present modification example will be described.

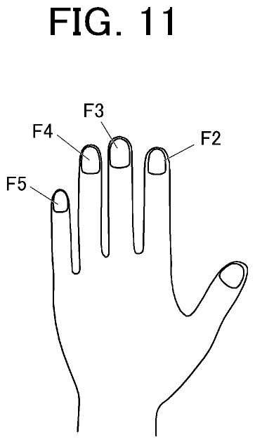

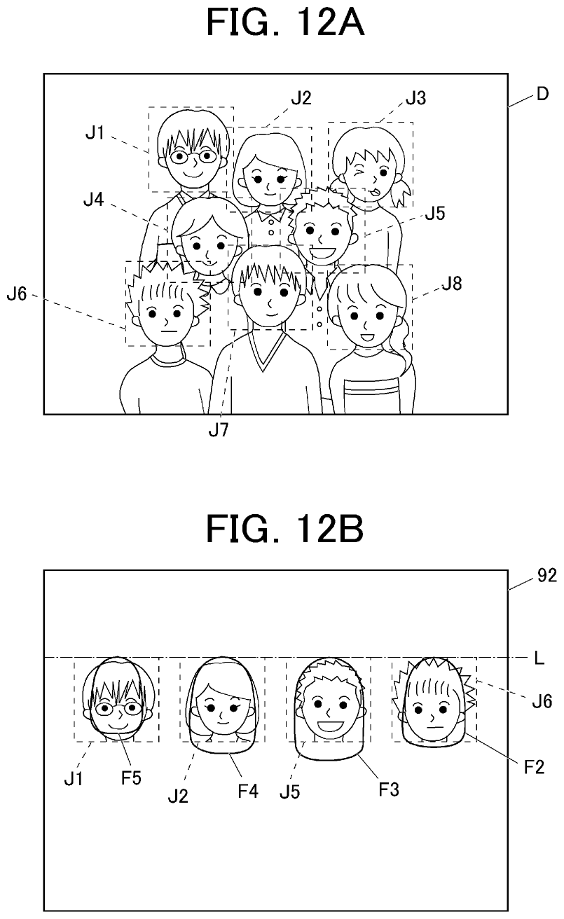

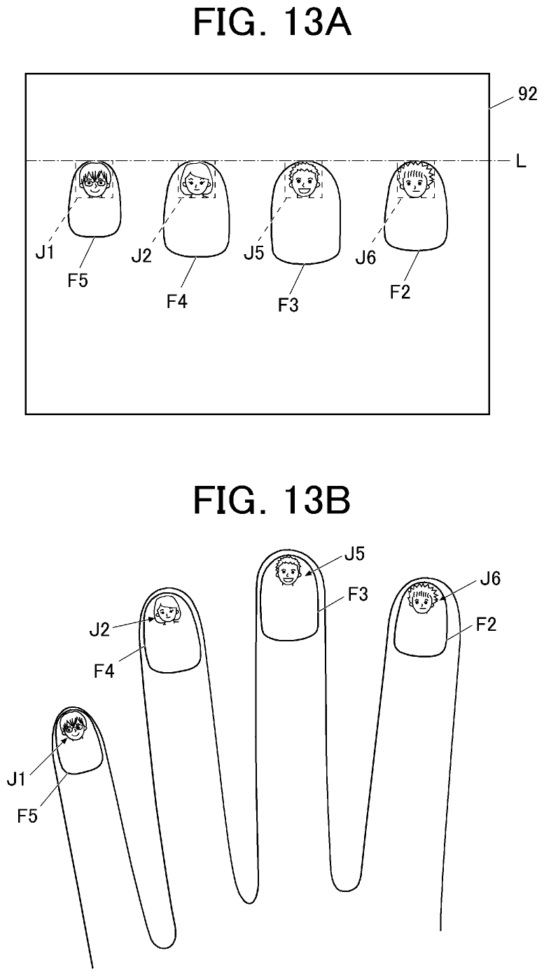

FIGS. 11 to 13A and 13B are views for explaining the present operation example. FIG. 11 is a view of selecting printing fingers, FIG. 12A is a view showing a printing design image from which the specific object images were extracted, and FIG. 12B is a view of displaying the multiple nail outlines and the specific object images positioned at the reference line. FIG. 13A is a view of the specific object images after performing scale adjustment to the specific object images with respect to the multiple nail outlines, and FIG. 13B is a view showing the printing results.

As shown in FIG. 11, in the present operation example, when the user selects the index finger, middle finger, ring finger and little finger of the left hand as printing fingers, the respective nail outlines F2 to F5 are selected (step U1).

After the selected nail outlines F2 to F5 are corrected on the basis of the settings of curved surface levels, the nail outlines F2 to F5 are displayed on the display 92 (step U2).

When the user next selects a portrait of multiple persons as a printing design image D (step U3), as shown in FIG. 12A, multiple face images are extracted as the specific object images from this printing design image D (step U4). In this step, four face images J1, J2, J5 and J6 among eight face images J1 to J8 which were extracted by using a face recognition algorithm are selected as the specific object images of the printing target by a user operation, for example.

As shown in FIG. 12B, the face images J6, J5, J2 and J1 are superimposed on the nail outlines F2 to F5 arranged to be aligned at the straight reference line L in the left-right direction and displayed on the display 92 (step U5). In this step, the nail outlines F2 to F5 and the face images J6, J5, J2 and J1 are arranged along the arrangement of fingers with the respective upper ends matching the reference line L. As for the positions in the left-right direction of the nail outlines F2 to F5 and the face images J6, J5, J2 and J1, the central lines of the corresponding nail outlines F2 to F5 and the face images J6, J5, J2 and J1 match each other.

At this time point (at the initial stage of displaying the nail outlines and the face images), each of the face images is arranged on the nail outline maintaining the extracted size, and extends outside the nail outline.

Thereafter, as shown in FIG. 13A, by a user operation, for example, the scale adjustment is performed to all of the face images J6, J5, J2 and J1 at a same rate such that the face image is located inside the minimum nail outline (step U6). The user may manually adjust the size to make each face image easy to see or the user may move each face image as needed.

The face images J6, J5, J2 and J1 corresponding to the respective nail outlines F2 to F5 are then extracted in the form of circumscribed quadrangles of the respective nail outlines, and the printing data corresponding to each of the nail outlines F2 to F5 is generated (step U7).

When printing is executed on the basis of each piece of the generated printing data, as shown in FIG. 13B, the face images J6, J5, J2 and J1 respectively associated with the nails of the index finger, middle finger, ring finger and little finger of the left hand (nail outlines F2 to F5) are printed on the corresponding nails.

In such a way, by performing the scale adjustment to the multiple specific object images (design portions) extracted from the original image (printing design image) at a same rate and allocating the specific object images to the nail regions, it is possible to perform printing on the respective nails in a manner of reflecting the difference in original size of the specific object images.

As described above, according to the present modification example, multiple specific object images (for example, face images) which were extracted from the printing design image in advance are associated with multiple nail outlines and printed. Thus, it is possible to suitably print specific object images of a common type on the multiple nails.

According to the present modification example, the sizes of the design portions are adjusted at a same rate such that the design portions are arranged in the respective corresponding nail outlines. Thus, it is possible to print each of the design portions in the corresponding nail while maintaining the mutual size relationship between the multiple design portions.

According to the present modification example, since the specific object images (design portions) are associated with the nail outlines on the basis of a predetermined reference line, it is possible to suitably perform positioning of the nails and the design portions with the reference line.

Though the embodiment (including modification examples) of the present disclosure has been described above, the present disclosure is not limited to such embodiment, and various modifications can be made within the scope of the present disclosure.

For example, in the present embodiment, fingers are placed in the finger fixing unit and photographed one by one. However, multiple fingernails may be photographed together. By this configuration, it is not necessary to repeat finger inserting in photographing and printing, and it is possible to suppress the deterioration of printing quality caused by the position shift of fingers.

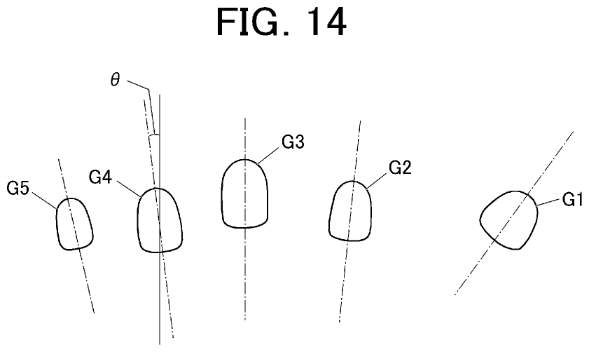

In especially the above case, the fingers easily get inclined. As shown in FIG. 14, for example, all the nails other than the nail of middle finger which is a reference (not inclined) among the respective nails G1 to G5 of the thumb, index finger, middle finger, ring finger and little finger are inclined. Thus, the inclination angle θ of each of the nails may be detected from the nail image to print the design corresponding to this inclination angle θ (for example, design similarly inclined by the inclination angle θ).

In the steps T6 and U7 of the design editing processing, when the design portion is extracted, the user may be allowed to specify the extraction range so as not to miss the design feature point, for example. In this case, the user may be allowed to specify the entire range to be printed on the multiple nail outlines, or may be allowed to specify the specific range to be printed on one of the nails.

The multiple design portions obtained from the printing design image are not particularly limited as long as the design portions correspond to the nail outlines and have designs (patterns including characters, marks or the like) which are related to each other.

In the present embodiment, the nail printing device 1 performs printing by the inkjet method. However, the method of performing printing by the nail printing device 1 is not limited to the inkjet method.

For example, printing may be performed with a pen by providing a pen holder that holds the pen for printing which performs printing with the pen tip contacting the nail surface. There may be provided both of the inkjet type printing unit as in the present embodiment and the pen holder holding the pen for printing so as to perform printing by using multiple printing units.

The present embodiment takes, as an example, a case where the nail printing device 1 forms a printing system in cooperation with the terminal device 9, inputting of an instruction to start printing or the like is performed with the terminal device 9, and then the printing operation is executed with the nail printing device 1. However, the nail printing device 1 is not limited to the device as shown in the present embodiment.

For example, an operating unit and/or a display for inputting various instructions, a printing data generating unit that generates printing data, and/or the like may be provided in the nail printing device 1 so that the control device of the nail printing device 1 performs these processing. By such a configuration, it is possible to configure the nail printing device 1 to be able to complete the printing operation alone without cooperating with the terminal device.

The various types of data such as a nail design (printing design image) and image data obtained by photographing may be stored in the storage of the terminal device, may be stored in the storage of the nail printing device 1, or may be obtained from the internet or any communicable device/equipment through the communicating unit.

The various types of data may be stored in a server device or the like which can be connected via a network line or the like so that the terminal device or the nail printing device 1 can access the server device or the like to refer to and obtain this data.

By such a configuration, it is possible to select a design to be printed from among more nail designs.

Although several embodiments of the present disclosure have been described, the scope of the present disclosure is not limited to the above described embodiments and includes the scope of the present disclosure that is described in the claims and the equivalents thereof.

What is claimed is:

1. A printing device comprising:
at least one processor that:
arranges multiple nail outlines based on a predetermined reference line, the nail outlines being outlines of multiple nails; and
obtains multiple image portions from an image, the image portions corresponding to the arranged nail outlines and including designs that are related to each other; and
a print head that prints the corresponding image portions on the respective nails.

2. The printing device according to claim 1, wherein the processor
obtains the image,
recognizes the nail outlines, and
associates the nail outlines with the image and extracts the image portions corresponding to the nail outlines from the image.

3. The printing device according to claim 2, wherein the processor
causes a display to superimpose and display the nail outlines and the image, and
adjusts a size and a position of the image and a gap between two adjacent nail outlines among the nail outlines.

4. The printing device according to claim 2, wherein the processor extracts the image portions corresponding to the nail outlines in a form of circumscribed quadrangles of the respective nail outlines.

5. The printing device according to claim 2, wherein the processor
extracts, in an integrated manner, the image portions in a form of a circumscribed quadrangle of the whole nail outlines, and
extracts the image portions corresponding to the respective nail outlines from the integrated image portions based on positions of the respective nail outlines in the circumscribed quadrangle.

6. The printing device according to claim 1, wherein the processor
obtains the image,
recognizes the nail outlines, and
associates, with the nail outlines, the image portions that are extracted from the image in advance.

7. The printing device according to claim 6, wherein the image portions are object images of a common type extracted from the image.

8. The printing device according to claim 6, wherein the processor changes sizes of the image portions at a same rate such that the image portions are arranged within the corresponding nail outlines.

9. The printing device according to claim 6, wherein the processor associates the image portions with the nail outlines based on the reference line.

10. The printing device according to claim 2, wherein the processor obtains an image of the nails by photographing the nails, and recognizes the nail outlines from the image of the nails.

11. The printing device according to claim 1, wherein the nails include nails of different persons.

12. A control method for a printing device, the method comprising:
arranging, by at least one processor, multiple nail outlines based on a predetermined reference line, the nail outlines being outlines of multiple nails;
obtaining, by the processor, multiple image portions from an image, the image portions corresponding to the arranged nail outlines and including designs that are related to each other; and
printing, by the processor, the corresponding image portions on the respective nails.

13. The control method according to claim 12, further comprising:
obtaining, by the processor, the image; and
recognizing, by the processor, the nail outlines, wherein
in the obtaining of the image portions, the nail outlines are associated with the image, and the image portions corresponding to the nail outlines are extracted from the image.

14. The control method according to claim 13, wherein in the obtaining of the image portions, the image portions corresponding to the nail outlines are extracted in a form of circumscribed quadrangles of the respective nail outlines.

15. The control method according to claim 13, wherein in the obtaining of the image portions,
the image portions are extracted in an integrated manner in a form of a circumscribed quadrangle of the whole nail outlines, and
the image portions corresponding to the respective nail outlines are extracted from the integrated image portions based on positions of the respective nail outlines in the circumscribed quadrangle.

16. The control method according to claim 12, further comprising:
obtaining, by the processor, the image; and
recognizing, by the processor, the nail outlines, wherein
in the obtaining of the image portions, the image portions that are extracted from the image in advance are associated with the nail outlines.

17. The control method according to claim 16, wherein sizes of the image portions are changed at a same rate such that the image portions are arranged within the corresponding nail outlines.

18. The control method according to claim 16, wherein in the obtaining of the image portions, the image portions are associated with the nail outlines based on the reference line.

19. The control method according to claim 13, wherein in the recognizing of the nail outlines, an image of the nails is obtained by photographing the nails, and the nail outlines are recognized from the image of the nails.

20. A non-transitory computer readable storage medium storing a program for a printing device, the program causing a computer to:
arrange multiple nail outlines based on a predetermined reference line, the nail outlines being outlines of multiple nails;
obtain multiple image portions from an image, the image portions corresponding to the arranged nail outlines and including designs that are related to each other; and
print the corresponding image portions on the respective nails with a printer.
